(19) United States
(12) Patent Application Publication
(10) Pub. No.: US 2017/0071316 A1
(43) Pub. Date: Mar. 16, 2017

(54) ADJUSTABLE MAGNIFYING MIRROR APPARATUS

(71) Applicants: Juan Carlos PEREZ, Charlotte, NC (US); Todd STANCOMBE, Charlotte, NC (US); Joy MANGANO, St. James, NY (US); Michael A. REED, Lake Saint Louis, MO (US); Shelly BRADY, Tulsa, OK (US)

(72) Inventors: Juan Carlos PEREZ, Charlotte, NC (US); Todd STANCOMBE, Charlotte, NC (US); Joy MANGANO, St. James, NY (US); Michael A. REED, Lake Saint Louis, MO (US); Shelly BRADY, Tulsa, OK (US)

(21) Appl. No.: 14/856,042

(22) Filed: Sep. 16, 2015

(51) Int. Cl. A45D 42/10; A45D 42/14; F21V 33/00; F21S 9/02; G02B 5/10; G02B 7/182

(52) U.S. Cl. CPC A45D 42/10; G02B 5/10; G02B 7/182; F21V 33/004; F21S 9/02; A45D 42/14

(57) ABSTRACT

A magnifying mirror apparatus for attachment to a mirror of a vanity area includes an annular frame and a magnifying mirror attached by a positioning arm to the annular frame. The annular frame defines an opening and has a front-facing side and a rear-facing side. The magnifying mirror is disposed generally within the opening of the annular frame and includes a first magnifying reflective body. The positioning arm is hingedly attached to the annular frame so as to permit rotational movement of the magnifying mirror, about a first generally vertically-oriented axis of rotation, away from the opening of the annular frame, thereby revealing a portion of the mirror of the vanity area visible through the opening of the annular frame

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

Field of the Present Invention

The present invention relates generally to magnifying mirrors for a vanity, and, in particular, to an improved adjustable magnifying mirror for a vanity.

Background

Personal mirrors are commonly found in a bathroom or vanity area of one's home, and are often used to assist with activities that require careful scrutiny such as application of make-up to one's face, shaving, or inspection of blemishes on one's face. Such personal mirrors are usually small hand-held or mountable mirrors that offer a level of magnification so that the user is better able to execute the activity with care and precision.

Many such personal mirrors are also mounted on a swivel so as to permit the mirror to be pivoted around an axis, thereby affording the user with a wider range of viewing versatility when conducting the activity. The axis of rotation is oriented vertically in some types of mirrors and is oriented horizontally in others. In both types of mirrors, the ability to rotate the mirror in a side-to-side direction or an up-down direction enhances the usability of the mirror and allows the user to orient the mirror to a position that is more suitable to the type of activity being conducted.

Known personal mirrors of the foregoing types are not without drawbacks. For instance, magnifying mirrors that exhibit higher levels of magnification can generate distortion for the user. This can generally be attributed to the physical construction of the mirror and, in particular, to the deformity in the reflective body that gives the mirror its magnifying quality. After prolonged use, such distortion can lead to disorientation for the user and can result in the user's inability to continue the activity being conducted in front of the magnifying mirror without first eliminating or resetting the source of the distortion (such as by viewing oneself in a unmagnified reflective body of a non-magnifying mirror).

In other contexts, known personal mirrors are unable to offer sufficient versatility in viewing options. Even with the ability to rotate in a side-to-side direction or an up-down direction, such mirrors can still be limited in their ability to be directed to a very specific orientation. A specific orientation may be necessary for a multitude of reasons, such as to enable a user to view the precise location of a facial blemish.

Accordingly, there exists a need for improvements in the field of magnifying mirrors for a bathroom or vanity area. These, and other needs, are addressed by one or more aspects of the present invention.

### SUMMARY OF THE PRESENT INVENTION

Some exemplary embodiments of the present invention may overcome one or more of the above disadvantages and other disadvantages not described above, but the present invention is not required to overcome any particular disadvantage described above, and some exemplary embodiments of the present invention may not overcome any of the disadvantages described above.

Broadly defined, the present invention according to one aspect includes a magnifying mirror apparatus for attachment to a mirror of a vanity area. The magnifying mirror apparatus includes an annular frame and a magnifying mirror attached by a positioning arm to the annular frame. The annular frame defines an opening and has a front-facing side and a rear-facing side. The magnifying mirror is disposed generally within the opening of the annular frame and includes a first magnifying reflective body. The positioning arm is hingedly attached to the annular frame so as to permit rotational movement of the magnifying mirror, about a first generally vertically-oriented axis of rotation, away from the opening of the annular frame, thereby revealing a portion of the mirror of the vanity area visible through the opening of the annular frame.

In a feature of this aspect, the magnifying mirror may include a second magnifying reflective body at a side opposite that of the first magnifying reflective body. In another feature of this aspect, the first magnifying reflective body may have a level of magnification that is different from that of the second magnifying reflective body.

In a feature of this aspect, the magnifying mirror may be attached to the positioning arm via a joining member that is attached at a distal end of the positioning arm. In other features of this aspect, the magnifying mirror may be hingedly attached to the joining member so as to permit rotational movement of the magnifying mirror about a second generally vertically-oriented axis of rotation; and/or the joining member may be attached to the distal end of the positioning arm via a rotational pin so as to permit tilting movement of the joining member about a generally horizontally-oriented axis of rotation. In another feature of this aspect, the joining member may be tiltable 180 degrees about the generally horizontally-oriented axis of rotation, thereby facilitating transition between the first magnifying reflective body facing outward and the second magnifying reflective body facing outward. In still another feature of this aspect, the joining member may include one or more nubs that become seated with one or more indentations at the distal end of the positioning arm when the magnifying mirror is oriented in a generally vertical orientation, thereby preventing the magnifying mirror from tilting freely.

In a feature of this aspect, the magnifying mirror apparatus may further include one or more suction cups disposed at the rear-facing side of the annular frame for facilitating attachment of the annular frame to the mirror of the vanity area.

In a feature of this aspect, the magnifying mirror apparatus may further include an annular case housing a light source, mounted at the front-facing side of the annular frame and disposed around the opening of the annular frame. In other features of this aspect, the annular case may be frosted or opaque; and/or powering the light source may illuminate the annular case, thereby lighting the portion of the mirror of the vanity area visible through the opening of the annular frame.

Broadly defined, the present invention according to another aspect includes a magnifying mirror apparatus. The magnifying mirror apparatus includes a frame, a positioning arm having proximal and distal ends, a joining member; and a magnifying mirror. The magnifying mirror includes a first magnifying reflective body at a first side and a second magnifying reflective body at a second side opposite of the first side. The positioning arm is hingedly attached at its proximal end to the frame, thereby permitting rotational movement of the positioning arm about a first generally vertically-oriented axis of rotation. The joining member is attached to the distal end of the positioning arm via a rotational pin, thereby permitting tilting movement of the joining member about a generally horizontally-oriented axis of rotation. The magnifying mirror is hingedly attached to the joining member, thereby permitting rotational movement of the magnifying mirror about a second generally vertically-oriented axis of rotation.

In a feature of this aspect, the magnifying mirror apparatus may further include one or more suction cups disposed at a rear-facing side of the frame for facilitating attachment of the frame to a surface.

In a feature of this aspect, the joining member may be tiltable 180 degrees about the generally horizontally-oriented axis of rotation, thereby facilitating transition between the first magnifying reflective body facing outward and the second magnifying reflective body facing outward.

Broadly defined, the present invention according to another aspect includes an apparatus for attachment to a mirror of a vanity area. The apparatus includes an annular frame, an annular case and one or more suction cups. The annular frame defines an opening and has a front-facing side and a rear-facing side. The annular case, which houses a light source, is mounted at the front-facing side of the annular frame and is disposed around the opening of the annular frame. One or more suction cups are disposed at the rear-facing side of the annular frame for facilitating attachment of the annular frame to the mirror of the vanity area. Powering the light source illuminates the annular case, thereby lighting a portion of the mirror of the vanity area visible through the opening of the annular frame.

In features of this aspect, the apparatus may further include a power switch disposed on the annular frame for actuating power to the light source; the annular case may be frosted or opaque; the light source may be powered by one or more batteries housed within the annular frame; and/or the apparatus may further include one or more tabs that retain the annular case against the annular frame.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a front view of an adjustable magnifying mirror apparatus, shown attached to the mirror of a conventional vanity, in accordance with one or more aspects of the present invention;

FIG. 2 is an enlarged front view of the adjustable magnifying mirror apparatus of FIG. 1;

FIG. 3 is an isometric rear view of the adjustable magnifying mirror apparatus of FIG. 2;

FIG. 4 is an isometric rear view of the adjustable magnifying mirror apparatus of FIG. 2, shown with a positioning arm extended outward;

FIG. 5 is an isometric rear view of the adjustable magnifying mirror apparatus of FIG. 2, shown with the positioning arm extended outward and tilted upward; and

FIG. 6 is an enlarged fragmentary front view of a portion of the adjustable magnifying apparatus of FIG. 5.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiment(s) is merely exemplary in nature and is in no way intended to limit the invention, its application, or uses.

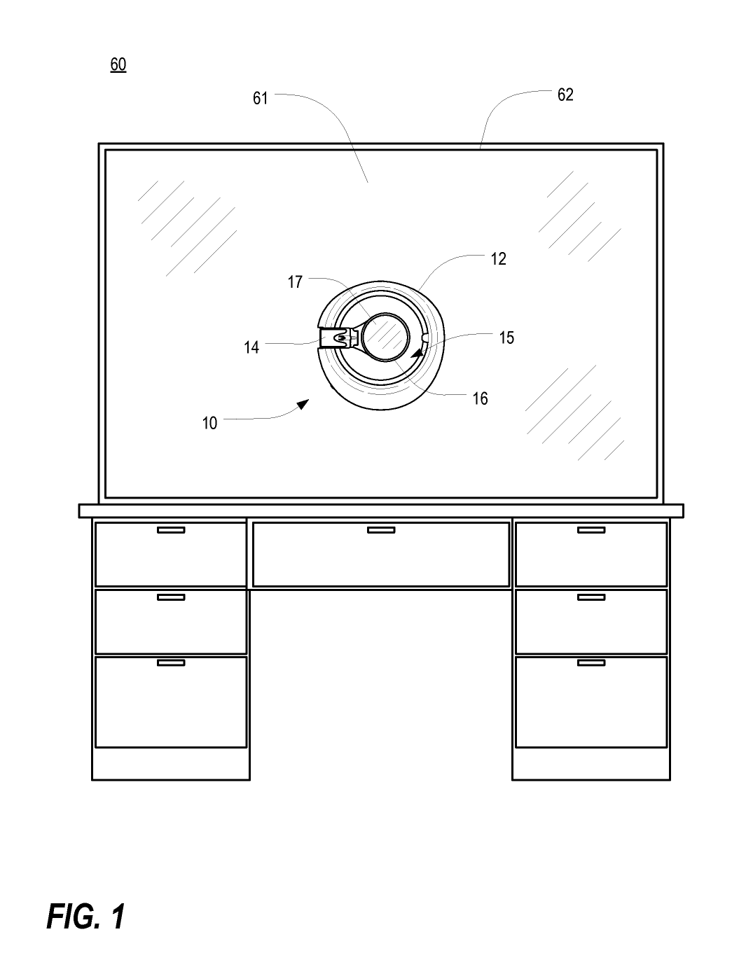

FIG. 1 is a front view of an adjustable magnifying mirror apparatus 10, shown attached to the mirror 62 of a conventional vanity 60, in accordance with one or more aspects of the present invention,. As shown in FIG. 1, the adjustable magnifying mirror apparatus 10 generally includes an annular frame 12 having a positioning arm 14 attached thereto. The positioning arm 14 supports an adjustable magnifying mirror 16 that is capable of being arranged at any of a wide range of angles or orientations that may be desired by the user, as will be explained in greater detail below. Though the annular frame 12 has a generally circular or oval shape in the embodiment depicted in FIG. 1, it is contemplated that the annular frame 12 may have any of a variety of different shapes and that a common characteristic across different embodiments is the existence of an opening 15 defined by the frame.

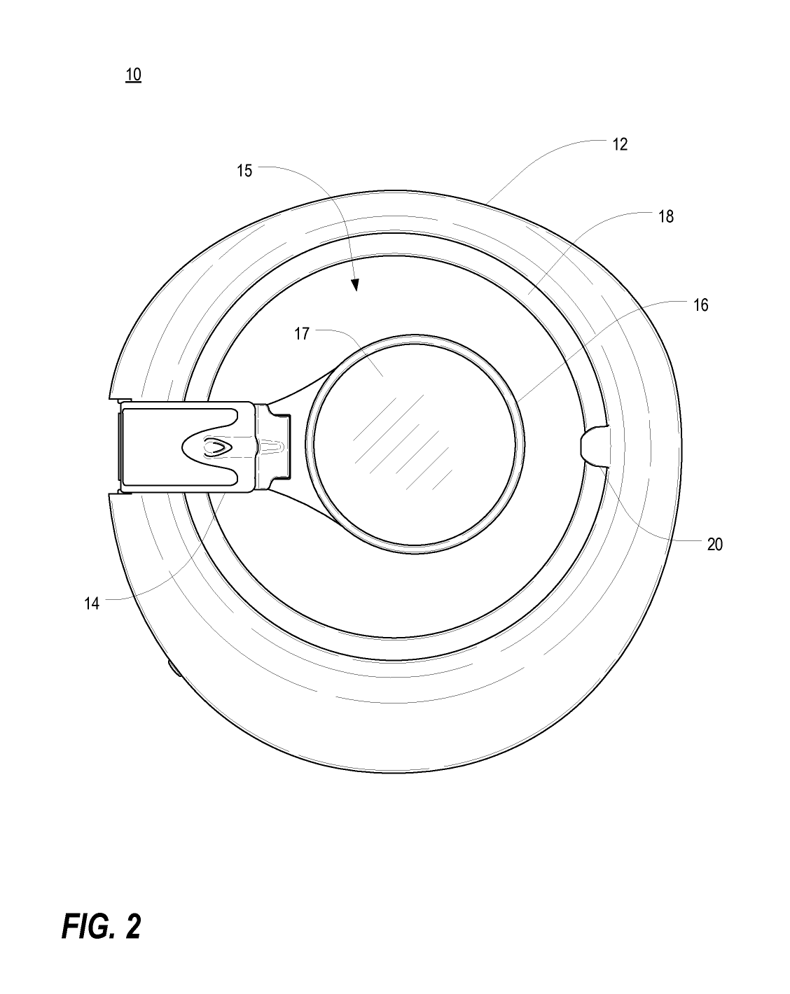

In at least some embodiments, the adjustable magnifying mirror 16 is dual-sided and includes a reflective body 17,19 at each side thereof (as can be seen across FIGS. 2-6). Each reflective body 17,19 of the mirror 16 may be configured to exhibit a desired magnification. Furthermore, it is contemplated that the level of magnification of the reflective bodies 17,19 may be different for each side of the mirror 16, thereby providing the user with an enhanced range of magnification options during use.

As further shown in FIG. 1, the magnifying mirror apparatus 10 of the present invention is attachable to the mirror 62 of a conventional vanity 60. In this manner, it is contemplated that the user can select between using the mirror 62 of the conventional vanity 60, which generally provides an unmagnified reflective body 61, and one of the two magnifying reflective bodies 17,19 of the magnifying mirror 16. In this regard, it is further contemplated that the unmagnified reflective body 61 of the conventional vanity can offer the user an easily accessible alternative to the magnifying reflective bodies 17,19 of the mirror apparatus 10. With the mirror apparatus 10 being mounted directly on the vanity mirror 62, a user can easily shift his or her gaze away from the magnifying reflective bodies 17,19 of the mirror apparatus 10 and over to the unmagnified reflective body 61 of the vanity mirror 62 in order to regain normal perspective or to eliminate lingering distortion arising from prolonged use of the mirror apparatus 10. Furthermore, because the mirror 16 of the apparatus 10 is mounted at the end of the positioning arm 14 (as discussed in greater detail below), the user can move the mirror 16 out of the way merely by rotating the positioning arm 14 so that the mirror 16 is pivoted sufficiently away from the annular frame 12. In this manner, the user is provided with ready access to the unmagnified reflective body 61 of the mirror 62, which can be seen through the opening 15 left behind in the annular frame 12.

Though FIG. 1 depicts the apparatus 10 attached to the mirror 62 of a vanity 60, it is further contemplated that in at least some modes of use, the apparatus 10 is attachable to other surfaces and articles as well, and is capable of installation in any of a variety of locations where there may exist a need for a magnifying reflective body.

FIG. 2 is an enlarged front view of the adjustable magnifying mirror apparatus 10 of FIG. 1. As shown in FIG. 2, the adjustable magnifying mirror apparatus 10 further includes an annular case 18 seated against an interior edge at the front of the annular frame 12. The annular case 18 houses one or more light sources, such as a conventional annular fluorescent bulb (not shown) or a series of small bulbs arranged in a ring, that can be powered on or off as desired by the user. The light source generally surrounds the adjustable magnifying mirror 16 of the apparatus 10 and, in this way, helps to illuminate the user's face, the adjustable magnifying mirror 16, a portion of the vanity mirror 62, or the like when in use. It is contemplated that the annular case 18 can be frosted or opaque so as to reduce glare or brightness of the light source. It is further contemplated that the annular case 18 can, itself, function as a light source. Whether the annular case 18 houses a light source or functions as a light source on its own, it is contemplated that the annular case 18 is removable from the frame 12 in order to facilitate replacement of the light source (e.g., in the event that the light source is damaged or is otherwise in need of replacement).

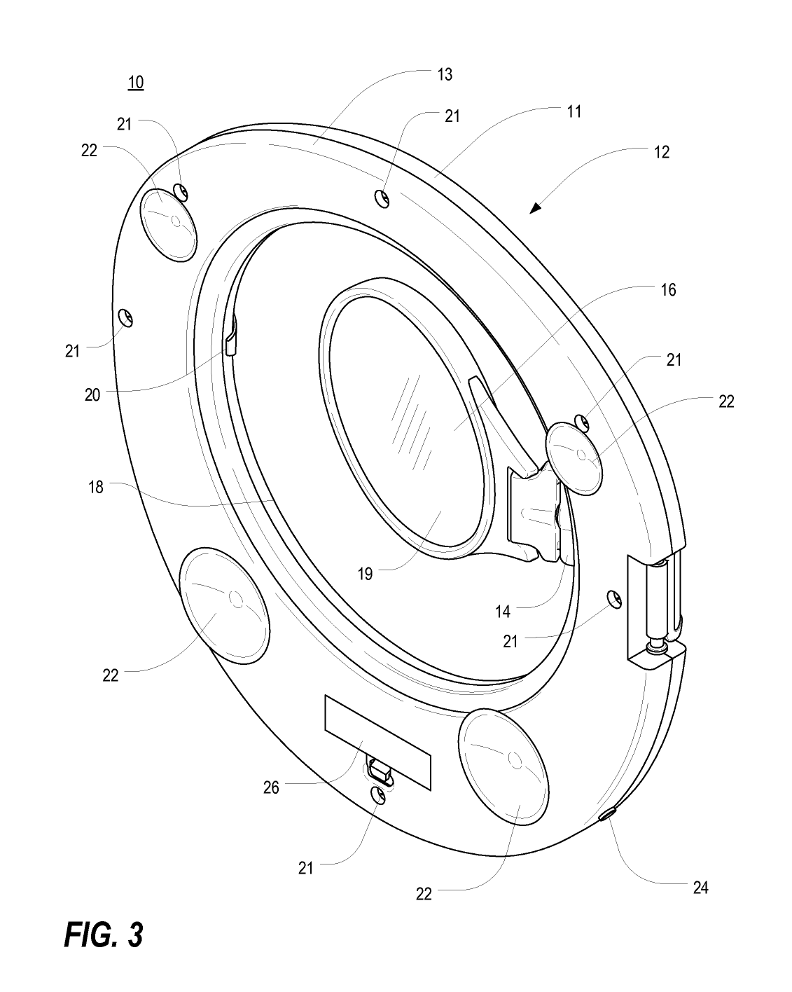

As perhaps best shown in FIGS. 2 and 3, maintaining the annular case 18 in position may be aided, at least in part, by one or more tabs 20 that extend over and grip the annular case 18. It is contemplated that such tabs 20 can be spaced generally evenly along the annular case 18. In one contemplated embodiment, two such tabs 20 are spaced opposite one another. It is further contemplated that additional tabs can be used to retain the annular case 18 in proper position on the frame 12.

FIG. 3 is an isometric rear view of the adjustable magnifying mirror apparatus 10 of FIG. 2. In at least some embodiments, the annular frame 12 of the adjustable magnifying mirror apparatus 10 is comprised of a front half 11 and a rear half 13 that are attached to one another to define an interior cavity (not illustrated). As shown in FIG. 3, a plurality of fasteners or threaded fittings (e.g., screws) 21 are utilized to attach the rear half 13 to the front half 11.

Housed within the frame 12, the annular case 18, or both are the light source, a power source to provide power to the light source, and requisite wiring and electrical components to power the light source. In one contemplated embodiment, one or more conventional batteries (e.g., AA or AAA size batteries, or the like) are used to provide power to the light source. In this regard, the rear frame 13 includes a removable cover 26 that can be opened or temporarily removed in order to facilitate battery installation at the interior cavity of the annular frame 12. The annular frame 12 further includes a power switch or button 24 disposed thereon that allows a user to power the light source on or off, as desired. In some embodiments, other lighting functions and corresponding controls can be provided, such as adjusting between different brightness settings.

In one contemplated embodiment, the annular frame 12, including the front and rear halves 11,13, is made from a durable, polymeric material. Other classes of durable materials are likewise contemplated. Though the size of the annular frame 12 may be varied to suit the needs of a particular installation location, the annular frame 12 of one contemplated embodiment has an outer diameter ranging from about 20 cm to about 25 cm and an interior diameter ranging from about 14 cm to about 18 cm. The mirror 16 of the mirror apparatus 10 is sized so as to fit within the inner diameter of the annular frame 12.

As further shown in FIG. 3, the adjustable magnifying mirror apparatus 10 further includes a plurality of suction cups 22 arranged intermittently along the rear half 13 of the annular frame 12. The suction cups 22 facilitate attachment of the apparatus 10 to the mirror of a conventional vanity (such as shown in FIG. 1) or other bathroom mirror. It is further contemplated that the suction cups 22 facilitate attachment of the apparatus 10 to any other surface to which the suction cups 22 adhere, including but not limited to glass surfaces or plastic surfaces. In the embodiment depicted in FIG. 3, the apparatus 10 includes four suction cups 22, which are spaced generally evenly along the annular shape of the rear half 13 of the frame 12. In other contemplated embodiments, the apparatus 10 can include a larger or smaller number of suctions cups 22, depending on the size of the frame 12 or on other factors. Furthermore, as shown in FIG. 3, it is contemplated that the suction cups 12 can themselves vary in size.

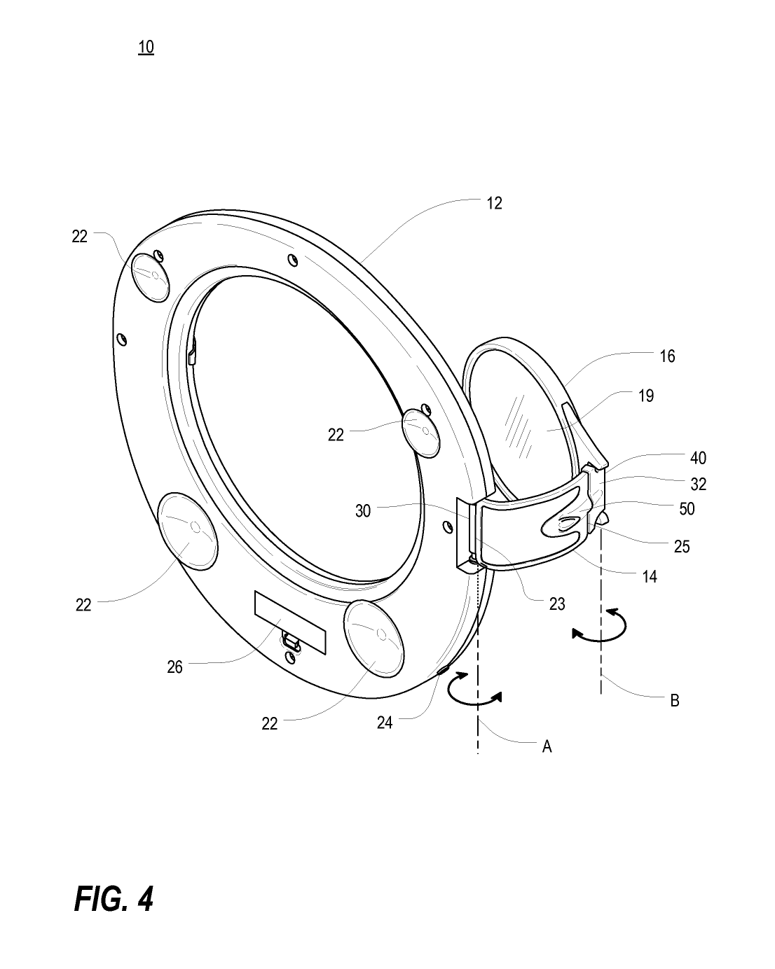

FIG. 4 is an isometric rear view of the adjustable magnifying mirror apparatus 10 of FIG. 2, shown with a positioning arm 14 extended outward. As shown in FIG. 4, a proximal end 23 of the positioning arm 14 is pivotably attached to the annular frame 12 of the mirror apparatus 10 at a first hinge 30. The first hinge 30 permits rotation of the positioning arm 14 about a first vertically-oriented axis of rotation A. Attached at a distal end 25 of the positioning arm 14 is a separate joining member 32 that interconnects the positioning arm 14 and the mirror 16. As further shown in FIG. 4, the mirror 16 is pivotably attached to the joining member 32 at a second hinge 40. The second hinge 40 permits rotation of the mirror 16 about a second vertically-oriented axis of rotation B.

Referring back to FIG. 3, it will be appreciated that in one state, the positioning arm 14 may be disposed so that the mirror 16 is generally arranged within the annular frame 12 of the apparatus 10. The first hinge 30 allows the user to rotate the positioning arm 14 away from the annular frame 12 around axis of rotation A, as can be seen in FIG. 4, thereby bringing the mirror 16 away from the annular frame 12 and closer to the user. If desired, the first hinge 30 even permits the positioning arm 14 to be rotated sufficiently away from the annular frame 12 so as to provide the user with ready access to the portion of the unmagnified reflective body 61 of the vanity mirror 62, which is surrounded by and visible through the opening 15 of the annular frame 12. Furthermore, as can also be seen in FIG. 4, the second hinge 40 allows the user to rotate the mirror 16, relative to the positioning arm 14 and/or the joining member 32, around axis of rotation B, in order to more precisely arrange the mirror 16 for use.

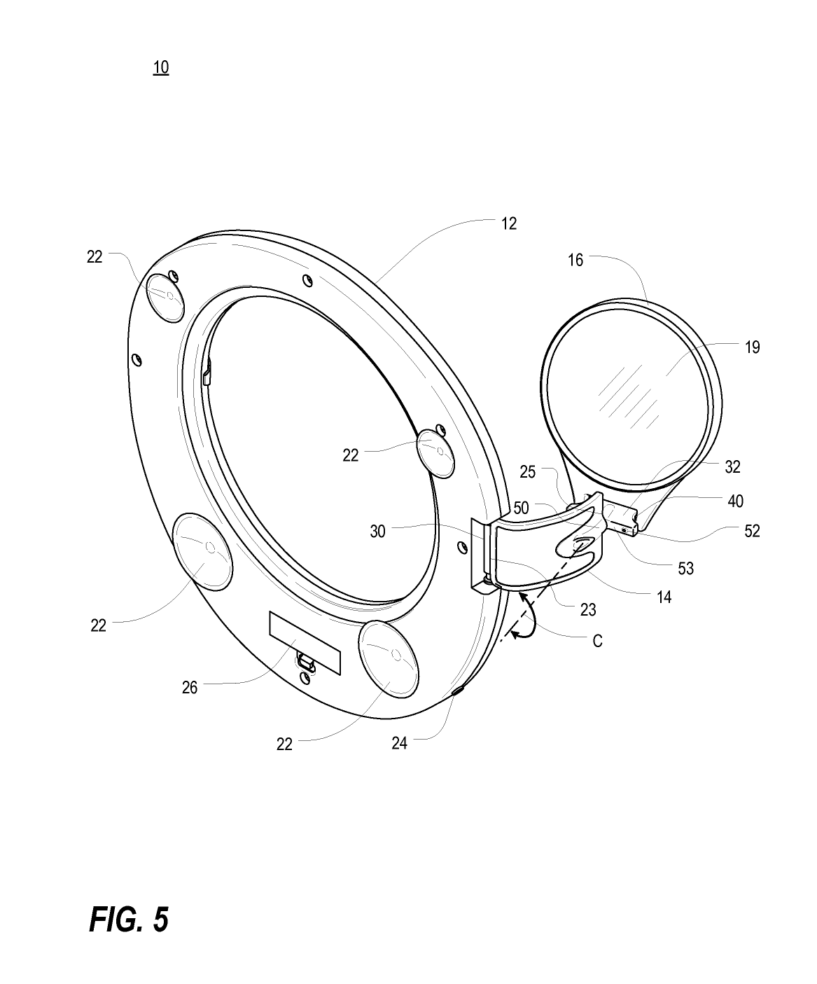

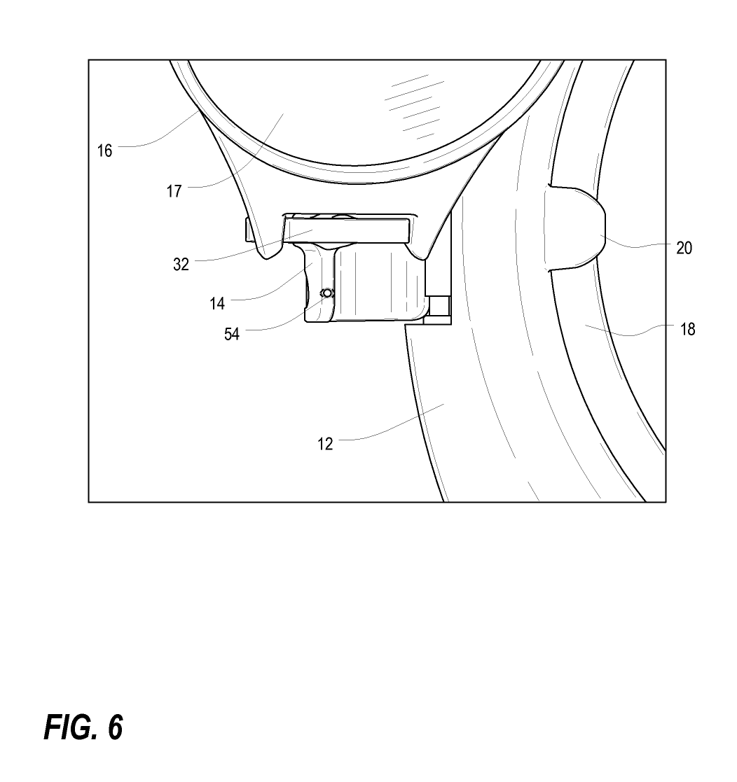

FIG. 5 is an isometric rear view of the adjustable magnifying mirror apparatus 10 of FIG. 2, shown with the positioning arm 14 extended outward and tilted upward, and FIG. 6 is an enlarged fragmentary front view of a portion of the adjustable magnifying apparatus 10 of FIG. 5. As shown in FIG. 5, the joining member 32 is pivotably attached to the distal end 25 of the positioning arm 14 by a rotation pin 50 that defines a horizontally-oriented axis of rotation C. Opposed ends of the rotation pin 50 extend into the joining member 32 and the distal end 25 of the positioning arm 14, respectively. The rotation pin 50 facilitates twisting rotation of the joining member 32 (and the mirror 16, which is attached to the joining member 32) relative to the positioning arm 14.

The rotation pin 50 allows the user to tilt the mirror 16 upward or downward, as desired, and provides an additional level of precision to a user's ability to arrange the mirror 16 for use. Combining the rotational options provided by the first hinge 30, the second hinge 40 and the rotation pin 50, simultaneously, provides the user with an even wider range of precise mirror orientations. Furthermore, the rotation pin 50 permits the mirror 16 to be tilted by a full 180 degrees. In this regard, tilting of the mirror 16 about axis of rotation C also enables a user to select which magnifying reflective body 17,19 of the mirror 16 to use. Switching between magnifying reflective bodies 17,19 is accomplished simply by tilting the mirror 16, in either direction, by 180 degrees.

As shown in FIG. 5, the joining member 32 preferably includes one or more nubs 52 disposed on an edge 53 that faces the distal end 25 of the positioning arm 14. The one or more nubs 52 correspond and mate with one or more indentations 54 (as can be seen in FIG. 6) at the distal end 25 of the positioning arm 14. When the mirror 16 is oriented in a generally vertical orientation, the nubs 52 are seated in their corresponding indentations 54, and the mirror 16 is prevented from free rotation. However, when a small rotational force is applied to the mirror 16, the nubs 52 can be unseated from their corresponding indentations 54, and the mirror is free to be tilted upwardly or downwardly about axis of rotation C. Advantageously, the mirror 16 can be seated (with nubs 52 paired with corresponding indentations 54) with either of the two magnifying reflective bodies 17,19 facing outward for use. If the mirror 16 is seated with magnifying reflective body 17 facing outward, the mirror 16 must simply be tilted a full 180 degrees about axis of rotation C to reach a seated position with magnifying reflective body 19 facing outward.

Although the foregoing discussion describes the mirror apparatus 10 with hinges 30,40 and rotation pins 50, it is contemplated that other types and classes of rotational structures may be implemented to accomplish similar levels of versatility in orienting the magnifying mirror 16.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A magnifying mirror apparatus for attachment to a mirror of a vanity area, the magnifying mirror apparatus comprising:
an annular frame defining an opening and having a front-facing side and a rear-facing side; and
a magnifying mirror attached by a positioning arm to the annular frame and disposed generally within the opening of the annular frame, the magnifying mirror including a first magnifying reflective body;
wherein the positioning arm is hingedly attached to the annular frame so as to permit rotational movement of the magnifying mirror, about a first generally vertically-oriented axis of rotation, away from the opening of the annular frame, thereby revealing a portion of the mirror of the vanity area visible through the opening of the annular frame.

2. The magnifying mirror apparatus of claim 1, wherein the magnifying mirror includes a second magnifying reflective body at a side opposite that of the first magnifying reflective body.

3. The magnifying mirror apparatus of claim 2, wherein the first magnifying reflective body has a level of magnification that is different from that of the second magnifying reflective body.

4. The magnifying mirror apparatus of claim 2, wherein the magnifying mirror is attached to the positioning arm via a joining member that is attached at a distal end of the positioning arm.

5. The magnifying mirror apparatus of claim 4, wherein the magnifying mirror is hingedly attached to the joining member so as to permit rotational movement of the magnifying mirror about a second generally vertically-oriented axis of rotation.

6. The magnifying mirror apparatus of claim 4, wherein the joining member is attached to the distal end of the positioning arm via a rotational pin so as to permit tilting movement of the joining member about a generally horizontally-oriented axis of rotation.

7. The magnifying mirror apparatus of claim 6, wherein the joining member is tiltable 180 degrees about the generally horizontally-oriented axis of rotation, thereby facilitating transition between the first magnifying reflective body facing outward and the second magnifying reflective body facing outward.

8. The magnifying mirror apparatus of claim 4, wherein the joining member includes one or more nubs that become seated with one or more indentations at the distal end of the positioning arm when the magnifying mirror is oriented in a generally vertical orientation, thereby preventing the magnifying mirror from tilting freely.

9. The magnifying mirror apparatus of claim 1, further comprising one or more suction cups disposed at the rear-facing side of the annular frame for facilitating attachment of the annular frame to the mirror of the vanity area.

10. The magnifying mirror apparatus of claim 1, further comprising an annular case housing a light source, mounted at the front-facing side of the annular frame and disposed around the opening of the annular frame.

11. The magnifying mirror apparatus of claim 10, wherein the annular case is frosted or opaque.

12. The magnifying mirror apparatus of claim 10, wherein powering the light source illuminates the annular case, thereby lighting the portion of the mirror of the vanity area visible through the opening of the annular frame.

13. A magnifying mirror apparatus comprising:
a frame;
a positioning arm having proximal and distal ends;
a joining member; and
a magnifying mirror including a first magnifying reflective body at a first side and a second magnifying reflective body at a second side opposite of the first side;
wherein the positioning arm is hingedly attached at its proximal end to the frame, thereby permitting rotational movement of the positioning arm about a first generally vertically-oriented axis of rotation;
wherein the joining member is attached to the distal end of the positioning arm via a rotational pin, thereby permitting tilting movement of the joining member about a generally horizontally-oriented axis of rotation; and
wherein the magnifying mirror is hingedly attached to the joining member, thereby permitting rotational movement of the magnifying mirror about a second generally vertically-oriented axis of rotation.

14. The magnifying mirror apparatus of claim 13, further comprising one or more suction cups disposed at a rear-facing side of the frame for facilitating attachment of the frame to a surface.

15. The magnifying mirror apparatus of claim 13, wherein the joining member is tiltable 180 degrees about the generally horizontally-oriented axis of rotation, thereby facilitating transition between the first magnifying reflective body facing outward and the second magnifying reflective body facing outward.

16. An apparatus for attachment to a mirror of a vanity area, the apparatus comprising:
an annular frame defining an opening and having a front-facing side and a rear-facing side;
an annular case, housing a light source, mounted at the front-facing side of the annular frame and disposed around the opening of the annular frame; and
one or more suction cups disposed at the rear-facing side of the annular frame for facilitating attachment of the annular frame to the mirror of the vanity area;
wherein powering the light source illuminates the annular case, thereby lighting a portion of the mirror of the vanity area visible through the opening of the annular frame.

17. The apparatus of claim 16, further comprising a power switch disposed on the annular frame for actuating power to the light source.

18. The apparatus of claim 16, wherein the annular case is frosted or opaque.

19. The apparatus of claim 16, wherein the light source is powered by one or more batteries housed within the annular frame.

20. The apparatus of claim 16, further comprising one or more tabs that retain the annular case against the annular frame.
